(19) United States
(12) Patent Application Publication
(10) Pub. No.: US 2019/0102233 A1
(43) Pub. Date: Apr. 4, 2019

(54) METHOD FOR POWER OPTIMIZATION IN VIRTUALIZED ENVIRONMENTS AND SYSTEM IMPLEMENTING THE SAME

(71) Applicant: POLITECNICO DI MILANO, Milano (IT)

(72) Inventors: Marco Domenico Santambrogio, Cinisello Balsamo (IT); Matteo Ferroni, Rancio Valcuvia (IT); Marco Arnaboldi, Como (IT)

(21) Appl. No.: 15/724,928

(22) Filed: Oct. 4, 2017

(51) Int. Cl. G06F 9/50; G06F 9/455

(52) U.S. Cl. CPC G06F 9/5094; G06F 2209/501; G06F 2209/5011; G06F 9/45558

(57) ABSTRACT

A power optimization system and method for virtualized environments at least comprising a domain layer on which a plurality of virtual machines are implemented, a hardware layer and hypervisor layer configured for abstracting between the virtual machines of the domain layer and the hardware layer, wherein the system comprises a hardware interface to set a limit on the power consumption of at least one processing means implemented in a hardware layer and a software structure for performing an optimization of the available resource allocations for the running workload in terms of power consumption, wherein the software structure is an Observe-Decide-Act control loop structure, comprising an observe stage, a decide stage and an act stage, and wherein the observe stage interfaces with means configured for reading performance values inside at least one model specific register of the at least one processing means.

### TECHNICAL FIELD

The present invention relates to a method for power optimization in virtual environments and system implementing the same.

In particular, the present invention concerns a method for power optimization in datacentres having power budget constraints on the whole infrastructure, single clusters, and even single machines, and a virtualized environment implementing the method.

### BACKGROUND

In the era of Cloud Computing, services and computational power are provided in an “as-a-Service” (aaS) fashion, reducing the need of buying, building and maintaining proprietary systems. In the last few years, many services moved from being proprietary to the as-a-Service paradigm: this, together with virtualization techniques, allows multiple applications to easily run on the same machine. However, the burden of costs optimization is left to the Cloud Provider, that still faces the problem of consolidating multiple workloads on the same infrastructure. As power consumption remains one of the most impacting costs of any digital system, several approaches have been explored in literature to cope with power caps, trying to maximize the performance of the hosted applications.

Several works in the literature propose different approaches to both performance maximization under a power cap and power consumption minimization under performance constraints. For instance, some of them exploit Dynamic voltage scaling (DVFS) techniques and try to pack together similar threads, while others try to minimize the times the cores go into idle states, in order to save the power spent in going from an idle state back to an active one. Most of these works aims at reducing costs in datacentres or to increase battery life in power constrained devices.

Power optimization systems for computer clients are known which provide for a framework that aims to minimize and to maximize respectively the concept of timeliness and efficiency, wherein timeliness is intended as the ability of the system in enforcing a new cap, while efficiency is meant as the performance delivered by the applications under a fixed power cap. In order to achieve these goals, the known power optimization systems exploit both hardware (i.e., the Intel RAPL interface) and software (i.e., resource partitioning and allocation) techniques inside a canonical Observe-Decide-Act (ODA) control loop, one of the main building blocks of self-aware computing.

Even though the hybrid approach proposed by the known power optimization systems is effective, the Applicant identified two non-negligible limitations thereof: first, the applications running on the system need to be instrumented with the so-called Heartbeat framework, in order to provide a uniform metric of throughput to the decision phase; second, the tool is meant to work with applications running bare metal on Linux.

Both these conditions might not be met in the context of a multitenant virtualized environment, in which a virtualization layer allows the execution of multiple workloads and ensures isolation to each of them.

This is the case of the hypervisors widely adopted in real production environments, that run directly as an abstraction layer between the hardware and the hosted virtual machines, also called domains or tenants.

The hypervisor is based on a microkernel design, providing services that allow multiple operating systems to concurrently run on the same hardware. A privileged domain (usually called DomO) is in charge of managing the unprivileged domains (usually called DomU).

In this context, the high isolation of each tenant or domain, seen as a black box, makes any instrumentation of the code of the hosted applications not feasible in a real production environment.

### SUMMARY OF THE INVENTION

The above considered, Applicant contemplated the problem of obviating the above-mentioned drawbacks and, in particular, of providing for a system for power optimization suitable to be used in virtualized environments, namely a system suitable to be used in connection with datacentres.

Within the scope of the above problem, the Applicant considered the object of designing a system capable of maximizing performance of virtual machines of a virtualized environment while respecting a given power budget or minimizing power consumption while ensuring a defined service level agreement (SLA) quota.

A further object of the present invention consists in the provision of a system capable of performing a performance measurement of each virtual machine in order to provide information for allocating the processor resources.

Another object of the present invention consists in the provision of a system capable of performing a performance measurement of each virtual machine without interfacing with the datacentre managing software.

Accordingly, a first aspect of the present invention relates to a power optimization system for virtualized environments at least comprising a domain layer on which a plurality of virtual machines are implemented, a hardware layer and a hypervisor layer configured for abstracting between the virtual machines of the domain layer and the hardware layer, wherein the system comprises a hardware interface to set a limit on the power consumption of at least one processing means implemented in the hardware layer and a software structure for performing an optimization of the available resource allocations for the running workload in terms of power consumption, wherein the software structure is an Observe-Decide-Act control loop structure, comprising an observe stage, a decide stage and an act stage, and wherein the observe stage interfaces with means configured for reading performance values inside at least one model specific register (MSR) of the at least one processing means.

Applicant considered that by using performance values which can be counted by means of hypervisor-level instrumentation reduces the developer's effort in submitting their workloads, since no integration with external application programming interfaces is required.

Accordingly, Applicant advantageously studied a structure configured for providing precise attribution of hardware events to virtual machines, being agnostic to the mapping between virtual and physical resources, hosted applications and scheduling policies, and adding negligible overhead.

Applicant identified the possibility of reading performance values inside at least one model specific register (MSR) of the at least one processing means thereby achieving to get performance values which can be retrieved by means of hypervisor-level instrumentation.

A second aspect of the present invention relates to a method for power optimization in virtual environments at least comprising a domain layer on which a plurality of virtual machines is implemented, a hardware layer and a hypervisor layer configured for abstracting between the virtual machines of the domain layer and the hardware layer, wherein the method comprises the steps of:
limiting the power consumption of at least one processing means implemented in the hardware layer by means of a hardware interface; and
optimizing the resource allocation for a current workload running in the domain layer in terms of power consumption by means of an ODA control loop structure comprising an observe stage, a decide stage and an act stage;
   wherein the resource allocation optimizing step comprises collecting performance information for each running virtual machine by reading performance values inside at least one model specific register (MSR) of the at least one processing means.

Advantageously, the power optimization method of the invention achieves the technical effects described above.

The present invention in at least one of the above aspects may have at least one of the following preferred features; the latter may in particular be combined with each other as desired to meet specific implementation purposes.

Preferably, the performance values are the number of Instruction Retired (IR) accounted by each processing means in a time window.

Applicant recognized that instruction retired events are reasonable indicator of performance for a low-level metrics of performance in a certain time window. In detail, Applicant considered that instruction retired events are hardware events which give an insight on how many microinstructions are completely executed (i.e., that successfully reached the end of the pipeline) between two samples of the counter.

Moreover, Applicant realized that instruction retired events can perfectly suitable to be counted by means of hypervisor-level instrumentation which monitors the context switch between domains thereby not requiring any instrumentation of the code of the workload.

Preferably, the reading means are configured to enrich the performance values with information about a sampling time and/or the virtual machine to which the read performance values refer and/or the processing means from which the performance values are read.

More preferably, the observe stage interfaces with means configured for tracing back the read and/or collected information to the domain layer.

The tracing back procedure is conventionally implemented by the hypervisor layer by enabling a number of trace points at key locations which will trigger the writing of tracing information into per-CPU buffers within the hypervisor itself.

Even more preferably, the observe stage interfaces with means configured for retrieving information coming from each processing means through the tracing means, the retrieving means being configured to trace, reorder and aggregate the information over a defined time window.

Still of more preference, the observe stage interfaces with storing means in which the retrieved information is periodically stored.

Even more preferably, the storing means are set as read-only memory for further external applications.

Still of more preference, the observe stage interfaces means for setting to zero the at least one model specific register.

According to the structure studied by the Applicant a reliable value of performance is obtained from the MSRs and associated to the related virtual machine and processing means. Advantageously, this operation can be performed at the hypervisor level and does not require an instrumentation of the code of the workload. Based on the retrieved and calculated performance value, it is then possible to perform an optimization of the mapping between virtual machines processing means and real processing means.

Preferably, the decide stage of the control loop structure comprises allocation means configured for calculating the average of the values regarding performance retrieved by the observe stage.

Preferably, the power consumption limiting hardware interface is a Running Average Power Limit (RAPL) hardware interface.

More preferably, the act stage of the control loop structure interfaces with means configured for setting the RAPL hardware interface.

Even more preferably, the means configured for setting the RAPL hardware interface are configured for instrumenting the hypervisor layer with a new hypercall and for allowing an application to write in a model specific registers controlling the RAPL hardware interface.

Preferably, the act stage of the control loop structure interfaces with means configured for actuating a resource configuration selected by the allocation means of the decide stage.

More preferably, the means for actuating the resource configuration selected by the allocation means of the decide stage are configured for:
creating a pool of resources for each running virtual machine;
assigning an amount of each processing means to the pool of resources; and
mapping virtual processing means of each running virtual machine for a certain amount of time on each processing means assigned to the pool.

Preferably, the ODA control loop structure additionally comprises a prediction stage configured to further speed up the convergence to the optimal resource allocation.

Preferably, the read performance values and/or the collected information are traced back to the domain layer and reordered and aggregated over a defined time window.

Preferably, the aggregated information is stored in storing means to be available for being used as metrics of performance.

Preferably, the optimizing step comprises calculating the power efficiency of the current workload over a defined time window based on the collected performance values.

More preferably, the calculated power efficiency is the average of the performance values read in the register (MSR).

Preferably, the optimizing step comprises defining an optimized allocation in terms of power efficiency of a plurality of processing means comprised in the hardware layer to virtual processing means of each running virtual machine based on the calculated power efficiency.

More preferably, the optimizing step comprises implementing the optimized allocation by:
creating a pool of resources for each running virtual machine;
assigning an amount of each processing means to the pool of resources; and
mapping virtual processing means of each running virtual machine for a certain amount of time on each processing means assigned to the pool.

Preferably, the step of setting a power consumption limit to the processing means comprises the sub-step of instrumenting the hypervisor layer with a new hypercall and of allowing an application to write in the defined model specific registers controlling the RAPL hardware interface.

### BRIEF DESCRIPTION OF THE DRAWINGS

With reference to the attached drawings, further features and advantages of the present invention will be shown by means of the following detailed description of some of its preferred embodiments.

According to the above description, the several features of each embodiment can be unrestrictedly and independently combined with each other in order to achieve the advantages specifically deriving from a certain combination of the same.

In the said drawings,

FIG. 1 is a schematic model of a preferred embodiment of a system implementing the method for power optimization in virtual environments according to the invention;

FIG. 2 is a block diagram of a preferred implementation of the method for power optimization in virtual environments according to the invention.

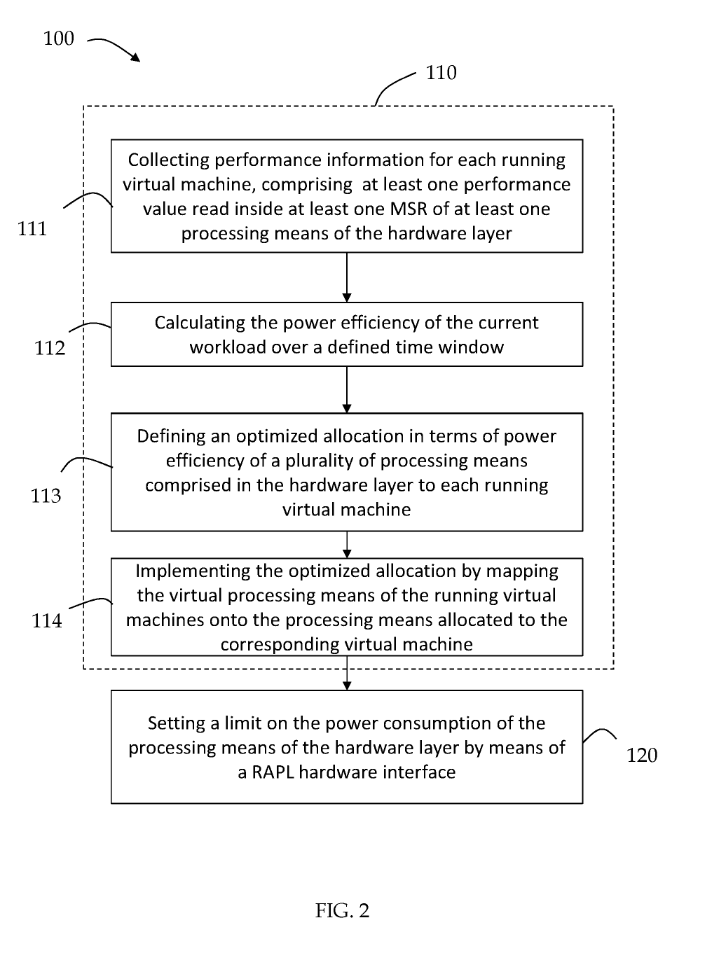

### DETAILED DESCRIPTION OF EMBODIMENTS

In the following description, to illustrate the figures identical reference numerals or symbols are used to indicate constructive elements with the same function. Moreover, for the sake of clarity of illustration, it is possible that some references are not repeated in all of the figures.

While the invention can undergo modifications, or be implemented in alternative ways, in the drawings some preferred embodiments are shown which will be discussed in detail in the following. However, it should be understood that there is no intention to limit the invention to the specific embodiments described, but on the contrary, the invention is meant to cover all the modifications or alternative and equivalent implementations that fall within the scope of protection of the invention as defined in the claims.

Expressions like “example given”, “etc.”, “or” indicate non-exclusive alternatives without limitation, unless expressly differently indicated. Expressions like “comprising” and “including” have the meaning of “comprising or including, but not limited to” unless expressly differently indicated.

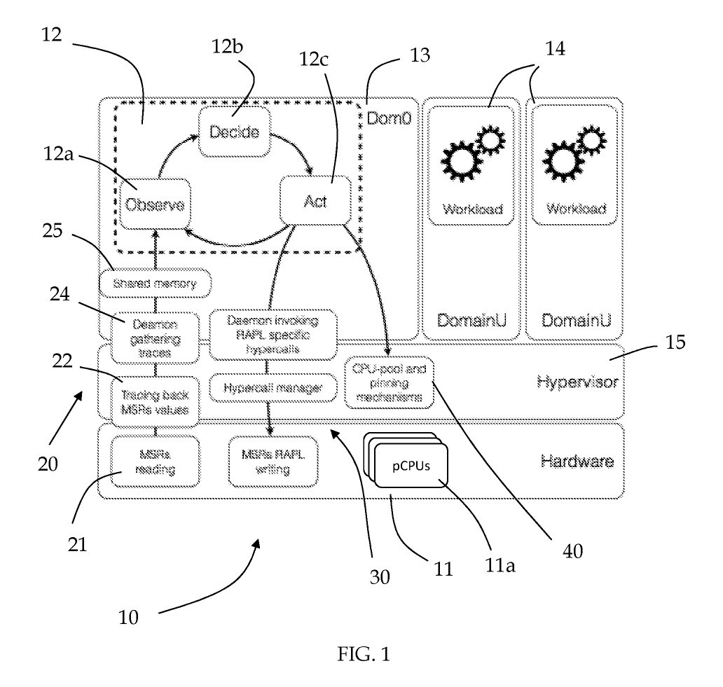

In FIG. 1, a system for power optimization in virtual environments according to the present invention is globally indicated with 10.

The system 10 of FIG. 1 is a hybrid hardware and software power optimization system, namely comprising a hardware interface to set a limit on the processor's power consumption implemented in a hardware layer 11 and a software structure 12 for performing an optimization of the available resource allocations for the running workload, in terms of power consumption.

In the depicted embodiment, the hardware layer 11 comprises a Running Average Power Limit (RAPL) hardware interface and the software structure 12 is an ODA control loop structure, namely a structure comprising an observe stage 12a, a decide stage 12b and an act stage 12c. The ODA control loop structure 12 is run on a privileged domain or virtual machine 13, which is in charge of managing a plurality of unprivileged domains or virtual machines 14. The privileged 13 and the unprivileged 14 domains are comprised in a domain layer 13,14.

Between the domain layer 13,14 and the hardware layer 11, a hypervisor layer 15 is provided. The hypervisor layer 15 is configured for abstracting between the virtual machines 13,14 and the hardware layer 11 thereby allowing multiple workloads and ensuring isolation to each of them.

Each different stage 12a,12b,12c of the ODA control loop structure 12 is configured to interact with different tools throughout all the layers 11,13,14,15 of the system 10: some tools are provided by each virtual machine of the domain layer 13,14 and the hypervisor layer 15.

According to the invention, the observe stage 12a of the control loop structure 12 interfaces with means 20 configured for instrumenting the scheduler of the hypervisor layer 15.

The instrumenting means 20 comprise means 21 for reading values regarding performance inside at least one model specific register (MSR) of at least one processing means 11a comprised in the hardware layer 11, e.g. a physical CPU or pCPU. The reading means 21 are configured to additionally enrich the read values with information about a sampling time, the virtual machine 13,14 to which the read values refer and the processing means 11a from which they are read.

Preferably, the values regarding performance are the number of Instruction Retired (IR) accounted by each processing means 11a in a certain time window. Among all the available hardware events that can be monitored, the IR events give an insight on how many microinstructions are completely executed (i.e., that successfully reached the end of the pipeline) between two samples of the counter, thus representing a reasonable indicator of performance.

The instrumenting means 20 further comprise means 22 for tracing back the read and collected information to the domain layer 13,14.

In addition thereto, the instrumenting means 20 also comprise means for setting to zero the at least one model specific register.

Moreover, the instrumenting means 20 comprise means 24 for retrieving information coming from each processing means 11a through the tracing means 22. The retrieving means 24 are configured to trace, reorder and aggregate the information over a defined time window.

Finally, the instrumenting means 20 comprise storing means 25 in which the retrieved information is periodically stored. The storing means 25 are set as read-only memory for further external applications.

The decide stage 12b of the control loop structure 12 comprises allocation means configured for calculating the average of the values regarding performance read by the instrumenting means 20 over the defined time window and defining an optimized allocation of a plurality of processing means 11a to each running virtual machine/workload.

The act stage 12c of the control loop structure 12 interfaces with means 30 for setting a desired power cap and means 40 for actuating the resource configuration selected by the allocation means of the decide stage 12b.

The means 30 for setting a desired power cap are configured for instrumenting the hypervisor layer 15 with a new hypercall and for allowing an application to write in the defined model specific registers controlling the RAPL hardware interface.

The means 40 for actuating the resource configuration selected by the allocation means of the decide stage 12b are configured for mapping virtual processing means of each running virtual machine 13,14 for a certain amount of time onto each processing means 11a associated to the corresponding running virtual machine 13,14.

The method for power optimization in virtual environments according to the present invention is globally indicated with 100 and comprises the following concurrent steps.

At a first step 110, the allocation of the available physical resources (pCPUs) for the workload running in the domain layer 13,14 of the virtual environment is optimized in terms of power consumption by means of an ODA control loop structure 12.

At a second step 120, a limit on the power consumption of the processing means 11a of the hardware layer 11 of the virtual environment is set by means of a RAPL hardware interface.

The optimization step 110 comprises the sub-steps of:
collecting 111 performance information for each running virtual machine 13,14;
based on the collected performance information, calculating 112 the power efficiency of the current workload over a defined time window;
based on the calculated power efficiency, defining 113 an optimized allocation in terms of power efficiency of a plurality of processing means 11a comprised in the hardware layer 11 to each running virtual machine 13,14; and
implementing 114 the optimized allocation by mapping a plurality of virtual processing means of each running virtual machine 13,14 onto the processing means 11a allocated on the related running virtual machine 13,14.

According to the invention, the collected performance information comprises at least one performance value read inside at least one model specific register (MSR) of at least one processing means 11a comprised in the hardware layer 11.

In this case, the power efficiency calculated at step 112 is the average of the performance value read in the register.

The read performance values are enriched with information about a sampling time, the virtual machine 13,14 the read values refer to, and the processing means 11a from which they are read.

After each reading, the at least one model specific register is set to zero.

The collected information is then traced back to the domain layer 13,14 and reordered and aggregated over a defined time window.

Finally, the aggregated information is stored in storing means 25 to be available for being used as metrics of performance.

The step 113 defining an optimized allocation of a plurality of processing means 11a to each running virtual machine comprises:
monitoring the calculated power efficiency of each virtual machine for a given time window;
if the monitored power efficiency remains substantially unvaried during the monitoring time, temporarily decrease the number of processing means 11a previously assigned to the virtual machine;
further monitoring the power efficiency of each virtual machine for a given second time window; and
in case the power efficiency decreases, increase the number of processing means 11a assigned to the virtual machine back to the number previously assigned.

The step of implementing 114 the optimized allocation comprises mapping virtual processing means of each running virtual machine 13,14 for a certain amount of time onto each processing means 11a associated to the corresponding running virtual machine 13,14.

The virtual processing means are mapped onto the physical ones 11a by covering the whole set of processing means 11a associated to the corresponding virtual machine, if possible.

In detail, given a workload with M virtual processing means of a virtual machine and an assignment to the said virtual machine of N physical processing means 11a, to each processing means 11a a number of virtual processing means according to the following equation is assigned:

$$vCPUs ( i ) = ⌈ \frac{M - {\sum }_{j = 0}^{i} vCPUs ( j )}{N - i} ⌉$$

where i is an integer between 0 and N−1, i.e., it spans over the set of physical processing means 11a.

Finally, the step 120 of setting a power consumption limit to the processing means 11a comprises instrumenting the hypervisor layer 15 with a new hypercall and of allowing an application to write in the defined model specific registers controlling the RAPL hardware interface.

1. A power optimization system for virtualized environments comprising a domain layer on which a plurality of virtual machines are implemented, a hardware layer and a hypervisor layer configured for abstracting between the virtual machines of the domain layer and the hardware layer, wherein the system comprises a hardware interface to set a limit on the power consumption of at least one processing means implemented in the hardware layer and a software structure for performing an optimization of the available resource allocations for the running workload in terms of power consumption, wherein the software structure is an Observe-Decide-Act control loop structure, comprising an observe stage, a decide stage and an act stage, and wherein the observe stage interfaces with a means configured for reading performance values inside at least one model specific register (MSR) of the at least one processing means.

2. The power optimization system of claim 1, wherein the performance values are the number of Instruction Retired (IR) accounted by each processing means in a time window.

3. The power optimization system of claim 1, wherein the reading means are configured to enrich the performance values with information about a sampling time and/or the virtual machine to which the read performance values refer and/or the processing means from which the performance values are read.

4. The power optimization system of claim 3, wherein the observe stage interfaces with a means configured for tracing back the read and/or collected information to the domain layer.

5. The power optimization system of claim 4, wherein the observe stage interfaces with means configured for retrieving information coming from each processing means through the tracing means, the retrieving means being configured to trace, reorder and aggregate the information over a defined time window.

6. The power optimization system of claim 5, wherein the observe stage interfaces with storing means in which the retrieved information is periodically stored.

7. The power optimization system of claim 1, wherein the decide stage of the control loop structure comprises allocation means configured for calculating the average of the values regarding performance retrieved by the observe stage.

8. The power optimization system of claim 1, wherein the power consumption limiting hardware interface is a Running Average Power Limit (RAPL) hardware interface.

9. The power optimization system of claim 8, wherein the act stage of the control loop structure interfaces with means configured for setting the RAPL hardware interface.

10. The power optimization system of claim 9, wherein the means configured for setting the RAPL hardware interface are configured for instrumenting the hypervisor layer with a new hypercall and for allowing an application to write in a model specific registers controlling the RAPL hardware interface.

11. The power optimization system of claim 1, wherein the act stage of the control loop structure interfaces with means configured for actuating a resource configuration selected by the allocation means of the decide stage.

12. The power optimization system of claim 11, wherein the means for actuating the resource configuration selected by the allocation means of the decide stage are configured for:
creating a pool of resources for each running virtual machine;
assigning an amount of each processing means to the pool of resources; and
mapping virtual processing means of each running virtual machine for a certain amount of time on each processing means assigned onto the pool.

13. A method for power optimization in virtual environments at least comprising a domain layer on which a plurality of virtual machines are implemented, a hardware layer and a hypervisor layer configured for abstracting between the virtual machines of the domain layer and the hardware layer, wherein the method comprises the steps of:
limiting the power consumption of at least one processing means implemented in the hardware layer by means of a hardware interface; and
optimizing the resource allocation for a current workload running in the domain layer in terms of power consumption by means of an ODA control loop structure comprising an observe stage, a decide stage and an act stage;
wherein the resource allocation optimizing step comprises collecting performance information for each running virtual machine by reading performance values inside at least one model specific register (MSR) of the at least one processing means.

14. The power optimization method of claim 13, wherein the performance values are the number of Instruction Retired (IR) accounted by each processing means in a time window.

15. The power optimization method of claim 13, wherein the read performance values are enriched with additional information about a sampling time, the virtual machine the read values refer to, and the processing means from which they are read.

16. The power optimization method of claim 15, wherein the read performance values and/or the collected information are then traced back to the domain layer and reordered and aggregated over a defined time window.

17. The power optimization method of claim 13, wherein the optimizing step comprises calculating the power efficiency of the current workload over a defined time window based on the collected performance values.

18. The power optimization method of claim 17, wherein the calculated power efficiency is the average of the performance values read in the register (MSR).

19. The power optimization method of claim 17, wherein the optimizing step comprises defining an optimized allocation in terms of power efficiency of a plurality of processing means comprised in the hardware layer to each running virtual machine based on the calculated power efficiency.

20. The power optimization method of claim 19, wherein the optimizing step comprises implementing the optimized allocation by mapping a plurality of virtual processing means of each running virtual machine for a certain amount of time, onto each processing means associated to the corresponding running virtual machine according to the following equation:
$$vCPUs ( i ) = ⌈ \frac{M - {\sum }_{j = 0}^{i} vCPUs ( j )}{N - i} ⌉$$
wherein M is the number of virtual processing means of a virtual machine, N is the number of physical processing means 11a assigned to the virtual machine and i is an integer between 0 and N−1.
